(19) United States
(12) Patent Application Publication
(10) Pub. No.: US 2002/0150238 A1
(43) Pub. Date: Oct. 17, 2002

(54) Benes fabric for bit level permutations

(76) Inventors: Mark Peting, Tigard, OR (US); Thad McCracken, Portland, OR (US)

Correspondence Address: Thomas C. Webster, Blakely, Sokoloff, Taylor, & Zafman LLP, 12400 Wilshire Boulevard,, Seventh Floor,, Los Angeles,, CA, 90025, US

(21) Appl. No.: 09/784,893

(22) Filed: Feb. 15, 2001

(51) Int. Cl. H04L 9/00

(52) U.S. Cl. 380/28

(57) ABSTRACT

Methods and apparatuses for bit-level permutations using a Benes fabric are described. In one embodiment, the Benes fabric includes an interconnection of multiple 2×2 switches. The 2×2 switches can be in either a pass-through state or a cross-over state. Each switch is coupled to a control circuit or a control register to control the state of the switch. The manner in which the 2×2 switches are interconnected allows a variety of bit permutations to be selected. The bit permutations can be used, for example, for encryption or decryption of digital data.

### FIELD OF THE INVENTION

The invention relates to circuits for performing permutations. More specifically, the invention relates to circuits to provide a Benes fabric to perform bit level permutations.

### BACKGROUND OF THE INVENTION

Cryptographic algorithms typically involve one or more permutations of data. For example, the Data Encryption Standard (DES) includes a key permutation, a compression permutation as well as other permutations. A permutation consists of transposing various bits of data to rearrange the bit ordering of the data. These permutations can be used in various combinations to encrypt and decrypt data. Permutation of bits can be used for other, non-cryptographic, purposes.

One common way to provide N-bit permutations is through the use of N N-input multiplexers. While this implementation is logically straight-forward, it results in a high gate count as N becomes large. The high gate count results in a relatively expensive implementation in terms of integrated circuit (IC) area.

An alternative is to hard wire permutations. Hard wiring permutations reduces the IC area required to implement the circuit. However, hard wiring the permutations also reduces the flexibility of the circuit.

### SUMMARY OF THE INVENTION

Multiple switches each having a first input terminal, a second input terminal, a first output terminal and a second output terminal are interconnected to provide bit permutations. Each of the switches has a pass-through state in which data input to the first input terminal is passed to the first output terminal and data input to the second input terminal is passed to the second output terminal, and a cross-over state in which data input to the first input terminal is passed to the second output terminal and data input to the second input terminal is passed to the first output terminal. The switches are interconnected to provide multiple permutations of signals input to the set of multiple switches.

### BRIEF DESCRIPTION OF THE DRAWINGS

The invention is illustrated by way of example, and not by way of limitation, in the figures of the accompanying drawings in which like reference numerals refer to similar elements.

FIG. 1a is a block diagram of a 2×2 switch in a pass-through state.

FIG. 1b is a block diagram of a 2×2 switch in a cross-over state.

FIG. 2 illustrates one embodiment of a 2×2 switch.

FIG. 3 illustrates one embodiment of a 64×64 Benes fabric implemented with 352 2×2 switches.

FIG. 4 illustrates one embodiment of a 4×4 Benes fabric and associated control register to configure the switches of the Benes fabric.

FIG. 5 is a flow diagram of a DES algorithm including multiple bit permutations that can be accomplished using a Benes fabric.

### DETAILED DESCRIPTION

Methods and apparatuses for permutation of data are described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Methods and apparatuses for bit-level permutations using a Benes fabric are described. In one embodiment, the Benes fabric includes an interconnection of multiple 2×2 switches. The 2×2 switches can be in either a pass-through state or a cross-over state. Each switch is coupled to a control circuit or a control register to control the state of the switch. The manner in which the 2×2 switches are interconnected allows a variety of bit permutations to be selected. The bit permutations can be used, for example, for encryption or decryption of digital data.

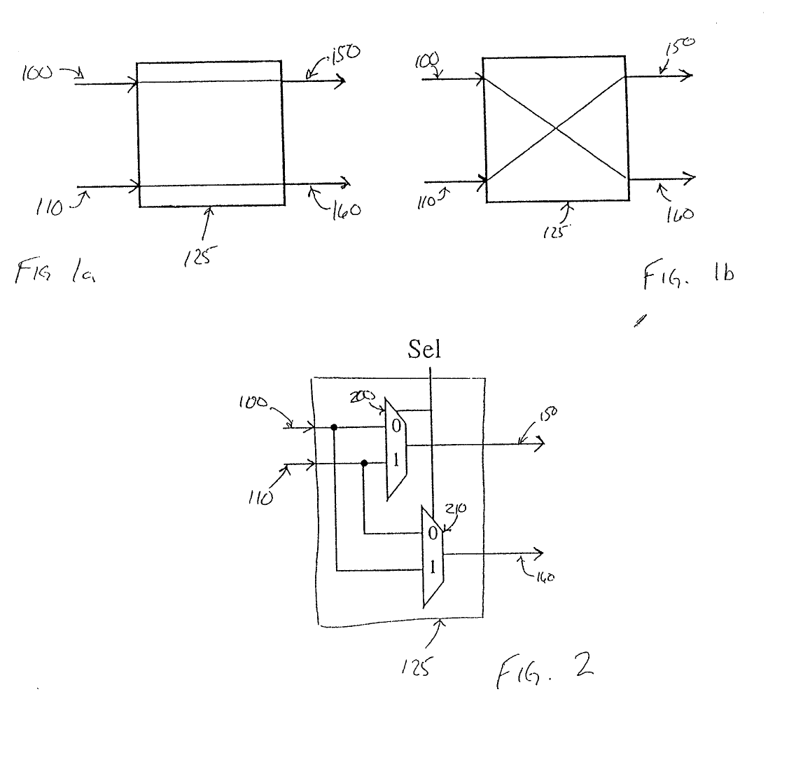

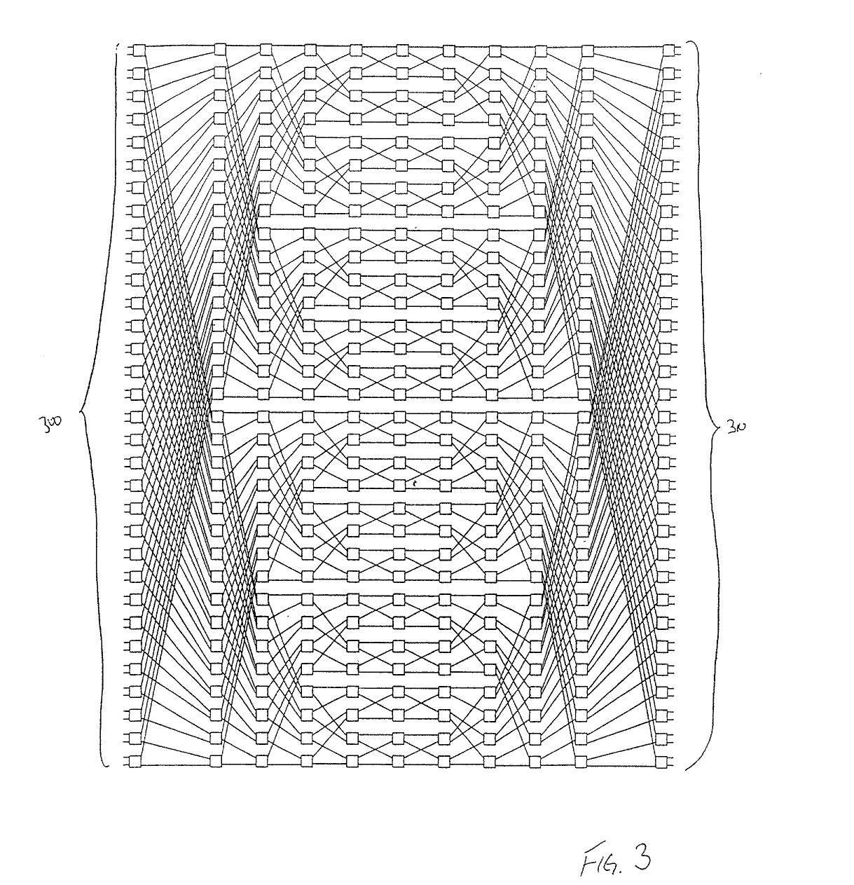

FIG. 1a is a block diagram of a 2×2 switch in a pass-through state. When switch 125 is in the pass-through state, signals provided to input terminal 100 are passed to output terminal 150 and signals provided to input terminal 110 are passed to output terminal 160. One embodiment of a 2×2 switch is described in greater detail below with respect to FIG. 2.

FIG. 1b is a block diagram of a 2×2 switch in a cross-over state. When switch 125 is in the cross-over state, signals provided to input terminal 100 are passed to output terminal 160 and signals provided to input terminal 110 are passed to output terminal 150.

FIG. 2 illustrates one embodiment of a 2×2 switch. The embodiment of FIG. 2 includes two two-input multiplexers coupled to a common select line. Use of a single select line reduces the number of select lines to control a fabric of interconnected 2×2 switches. However, use of a single select line can limit the flexibility of the fabric. In an alternate embodiment, multiplexer 200 and multiplexer 210 can be independently controlled. This allows an additional switch state in which one input is switched to both outputs.

Input terminals 100 and 110 provide input signals to multiplexers 200 and 210. A select signal (Sel) is provided by an external control circuit or control register (not shown in FIG. 2) to control operation of multiplexers 200 and 210. Multiplexers 200 and 210 selectively pass the signals from input terminals 100 and 110 to output terminals 150 and 160.

Multiplexers 200 and 210 pass signals provided to input terminals 100 and 110 to provide the functionality described above with respect to FIGS. 1a and 1b. Implementing a 2×2 switch as illustrated in FIG. 2 provides for pass-through and cross-over states, but does not provide for bit broadcasting. In other words, a signal input to one of input terminals 100 and 110 is passed to only one of output terminals 150 and 160. An input signal is not passed to multiple output terminals. In alternate embodiments, a signal input to one of terminals 110 and 110 can be passed to both of output terminals 150 and 160.

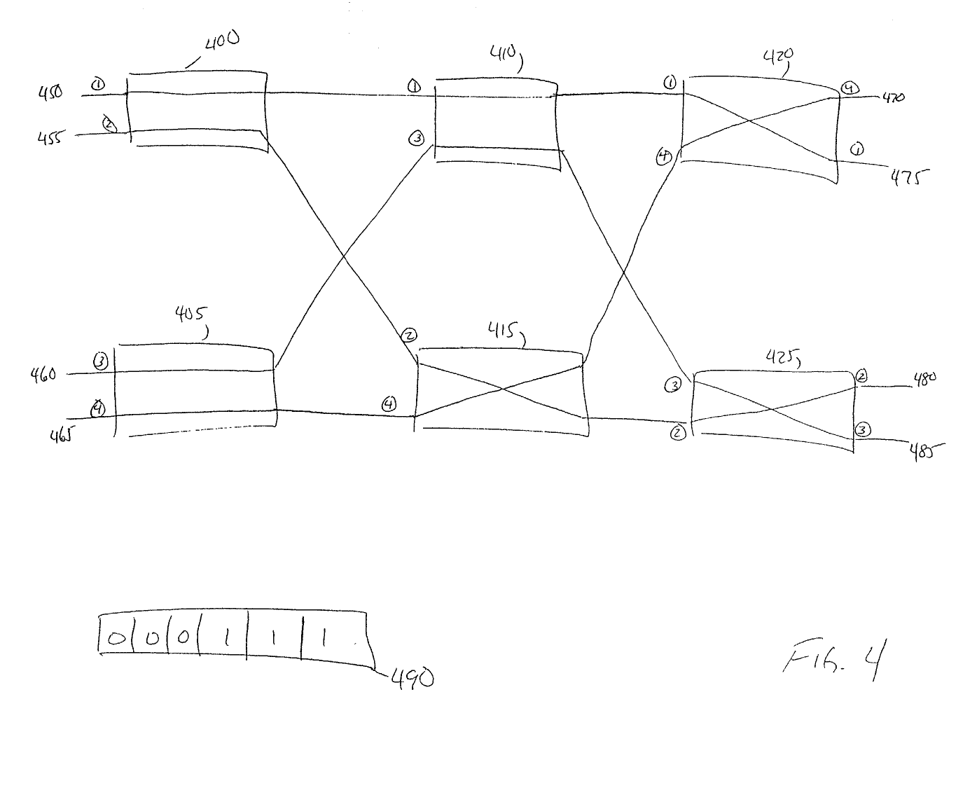

FIG. 3 illustrates one embodiment of a 64×64 Benes fabric implemented with 352 2×2 switches. Different size Benes fabrics can be implemented with a different number of 2×2 switches. The Benes fabric of FIG. 3 is described as a 64×11 fabric because 64 bits, or signals, are received and permuted through 11 layers of switches to output a 64-bit permutation of the input data.

In one embodiment, each switch is independently configurable and a 352-bit control register, or some other circuitry that can provide 352 control signals, is used to configure the Benes fabric. In alternate embodiments, a different number of control signals is used, which causes a change in the flexibility of the Benes fabric.

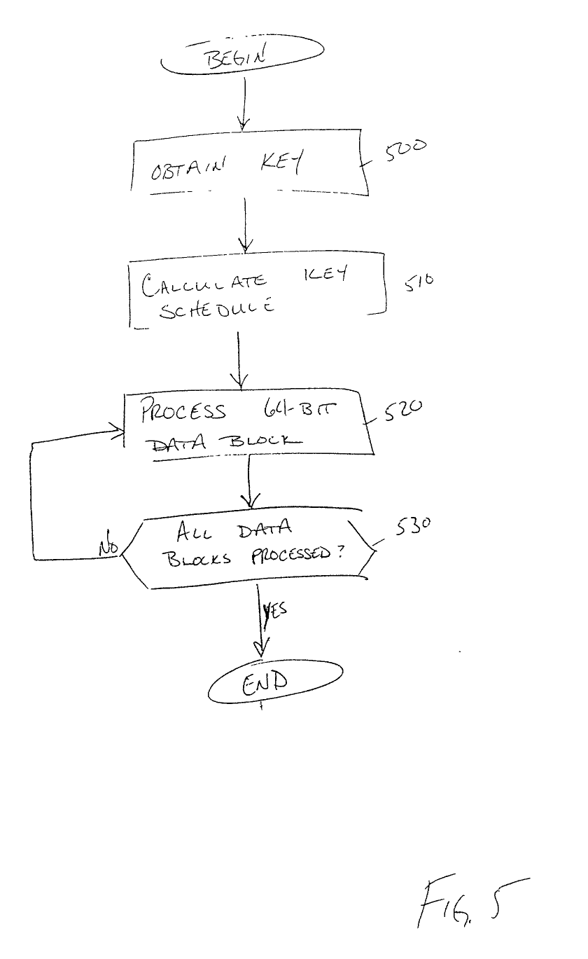

The control signals for the respective switches are provided to route the input signals received via input terminals 300 to the desired output terminals 310. Routing of signals through a smaller Benes fabric is described below with respect to FIG. 4. Determination of signal routing through the Benes fabric can be accomplished in any manner known in the art.

To compare the Benes fabric of FIG. 3 to a prior art multiplexer-based implementation, consider each 2:1 multiplexer as three 2-input logic gates, so that each switch includes six 2-input gates, for a total gate count of 2112 (=352×6) gates for the switching portion of the fabric. A prior art multiplexer-based fabric contains sixty-four 64:1 multiplexers, each of which consists of 189 2-input gates for a total gate count of 12,096 (=189×64). Because both implementations require a similar number of control bits, the control portion of the respective fabrics are ignored for purposes of this comparison.

Thus, the Benes fabric implementation described herein provides a simpler and less expensive circuit for providing bit-level permutations. The reduced number of gates results in a smaller silicon area required to implement the Benes fabric as an integrated circuit.

The Benes fabric described herein can be used for a variety of bit-level operations. These bit-level operations include, but are not limited to, permutations, circular shifts, endian swaps, and DES operations.

FIG. 4 illustrates one embodiment of a 2×3 Benes fabric and associated control register to configure the switches of the Benes fabric. For reasons of simplicity, the 2×2 switches of the Benes fabric and the control register contents are illustrated, but the coupling of the control register to the switches is omitted. For purposes of description with respect to the description of FIG. 4, a set bit (logical “1”) in the control register causes the associated 2×2 switch to be in the cross-over state and a clear bit (logical “0”) causes the associated 2×2 switch to be in the pass-through state.

The Benes fabric of FIG. 4 includes 2×2 switches 400, 405, 410, 415, 420 and 425. In the example of FIG. 4, the bits of control register 490, from left to right, control 2×2 switches 400, 405, 410, 415, 420 and 425, respectively. Thus, switches 400, 420 and 425 are in the pass-through state and switches 405, 410 and 415 are in the cross-over state.

The bits of control register 490 cause the Benes fabric to perform a circular shift; however, other bit-level operations can also be performed. The signal provided to input terminal 450 is passed through switches 400, 410 and 420 to output terminal 475. The signal provided to input terminal 455 is passed through switches 400, 415 and 425 to output terminal 480. The signal provided to input terminal 460 is passed through switches 405, 410 and 425 to output terminal 485. The signal provided to input terminal 465 is passed through switches 405, 425 and 420 to output terminal 470.

Thus, the output signal of the Benes fabric of FIG. 4 is a permuted version of the input signal. By controlling the states of the individual switches, the ordering of the output bits can be controlled to provide the desired permutation.

FIG. 5 is a flow diagram of a DES algorithm including multiple bit permutations that can be accomplished using a Benes fabric. The DES algorithm is an example of an environment in which a Benes fabric can be used for bit-level permutations. Bit-level permutations can be used for other purposes, whether for cryptographic purposes or non-cryptographic purposes.

The description with respect to FIG. 5 provides a brief overview of the DES algorithm and some of the permutations used in the DES algorithm. The DES algorithm is well known in the art and is not described in great detail herein.

A key is obtained at 500. In one embodiment, the key is 64 bits in length; however, for algorithms other than DES, other bit lengths can also be used. In one embodiment, every eighth bit of the 64-bit key is a parity bit and are discarded for encryption operations, which results in a 56-bit key.

A key schedule is calculated at 510. The bits of the 56-bit key are permuted as shown below.

| | | | | | | |
|---|---|---|---|---|---|---|
| 57 | 49 | 41 | 33 | 25 | 17 | 9 |
| 1 | 58 | 50 | 42 | 34 | 26 | 18 |
| 10 | 2 | 59 | 51 | 43 | 35 | 27 |
| 19 | 11 | 3 | 60 | 52 | 44 | 36 |
| 63 | 55 | 47 | 39 | 31 | 23 | 15 |
| 7 | 62 | 54 | 46 | 38 | 30 | 22 |
| 14 | 6 | 61 | 53 | 45 | 37 | 29 |
| 21 | 13 | 5 | 28 | 20 | 12 | 4 |

Bit 1 of the permuted block is bit 57 of the original key and bit 2 of the permuted block is bit 49 of the original key. These permutations can be accomplished using a Benes fabric described above.

The permuted key is split into two halves. The first 28 bits are referred to as C[0] and the last 28 bits are referred to as D[0]. Sixteen subkeys are generated from the permuted key. Circular left shifts are performed on the subkeys. The number of shifts that are performed on the subkeys is predetermined by the DES algorithm. The circular left shifts for encryption can be performed by the Benes fabric. Circular right shifts for decryption can also be performed by the Benes fabric.

One or more 64-bit blocks of data are processed at 520 and 530. Processing of the data blocks includes an initial permutation and an expansion, both of which can be performed by the Benes fabric. Processing of the data blocks includes other permutations as well.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

What is claimed is:

1. An apparatus comprising a plurality of switches each having a first input terminal, a second input terminal, a first output terminal and a second output terminal, each of the plurality of switches having a pass-through state in which data input to the first input terminal is passed to the first output terminal and data input to the second input terminal is passed to the second output terminal, and a cross-over state in which data input to the first input terminal is passed to the second output terminal and data input to the second input terminal is passed to the first output terminal, the plurality of switches interconnected to provide, at the output terminals of the plurality of switches, permutations of signals received via the input terminals of the plurality of switches.

2. The apparatus of claim 1 wherein one or more of the plurality of switches has a broadcast state in which data input to the one of the first input terminal and the second input terminal is passed to the first output terminal and to the second output terminal.

3. The apparatus of claim 1 wherein the plurality of switches comprises 352 switches coupled as 32 by 11 array to provide a 64-bit Benes fabric.

4. The apparatus of claim 1 wherein one or more of the plurality of switches comprises:
a first multiplexer coupled to the first input terminal an to the second input terminal to receive signals from the first input terminal and the second input terminal, the first multiplexer to pass signals from the first input terminal and the second input terminal to the first output terminal; and
a second multiplexer coupled to the first input terminal an to the second input terminal to receive signals from the first input terminal and the second input terminal, the second multiplexer to pass signals from the first input terminal and the second input terminal to the second output terminal.

5. The apparatus of claim 4 further comprising a control line to provide a control signal to the first multiplexer and to the second multiplexer such that when the control signal is in a first state the first multiplexer passes signals from the first input terminal to the first output terminal and the second multiplexer passes signals from the second input terminal to the second output terminal and when the control signal is in a second state the first multiplexer passes signals from the second input terminal to the first output terminal and the second multiplexer passes signals from the first input terminal to the second output terminal.

6. The apparatus of claim 1, wherein the plurality of switches are independently configurable.

7. The apparatus of claim 1 further comprising control circuitry coupled to the plurality of switches, the control circuitry to configure the plurality of switches.

8. A method comprising:
receiving a set of bits;
passing the set of bits through multiple layers of switches, wherein each of the switches operates in a pass-through state in which data input to the first input terminal is passed to the first output terminal and data input to the second input terminal is passed to the second output terminal, or a cross-over state in which data input to the first input terminal is passed to the second output terminal and data input to the second input terminal is passed to the first output terminal, the switches interconnected to provide multiple permutations of signals input to the plurality of switches; and
outputting a permuted version of the set of bits.

9. The method of claim 8 wherein the switches comprise 352 switches coupled as 32 by 11 array to provide a 64-bit Benes fabric.

10. The method of claim 8 further comprising providing a control signal to each of the switches, wherein the control signal causes the switches to be in either the pass-through state or the cross-over state.
11. The method of claim 10 wherein the control signals are retrieved from a control register.
